(19) United States
(12) Patent Application Publication
(10) Pub. No.: US 2026/0342185 A1
(43) Pub. Date: Oct. 29, 2026

(54) METHOD FOR MANUFACTURING STATOR FOR ROTATING ELECTRICAL MACHINE AND APPARATUS FOR MANUFACTURING STATOR FOR ROTATING ELECTRICAL MACHINE

(71) Applicant: AISIN CORPORATION, Kariya-Aichi (JP)

(72) Inventors: Hideharu USHIDA, Kariya-shi (JP); Taisuke NAKAMURA, Kariya-shi (JP); Taishu NAKANO, Kariya-shi (JP)

(73) Assignee: AISIN CORPORATION, Kariya-Aichi (JP)

(21) Appl. No.: 19/117,701

(22) PCT Filed: Sep. 21, 2023
(86) PCT No.: PCT/JP2023/034370

§ 371 Date: Apr. 2, 2025

(30) Foreign Application Priority Data
Oct. 11, 2022 (JP) 2022-163183

(51) Int. Cl. H02K 15/33; H02K 15/026

(52) U.S. Cl. CPC H02K 15/33; H02K 15/026; H02K 2215/00

(57) ABSTRACT

A method for manufacturing a stator for a rotating electrical machine is disclosed. The method includes: a step of bringing distal ends of one coil piece and another coil piece that form a stator coil of the rotating electrical machine into contact with each other; and a radiation step of emitting a laser beam with a wavelength of 0.6 μm or less toward one exposed side of a contact surface between the distal ends. The radiation step includes scanning the laser beam in a loop while moving the laser beam in a direction of travel including a directional component in which the exposed side extends. An amount of movement in the direction of travel per loop scan is equal to or less than a beam diameter of the laser beam.

### TECHNICAL FIELD

The present disclosure relates to methods for manufacturing a stator for a rotating electrical machine and apparatuses for manufacturing a stator for a rotating electrical machine.

### BACKGROUND ART

A technique is known that implements welding between coil pieces by bringing the distal ends of one coil piece and another coil piece into contact with each other and scanning a laser beam in a loop while moving the laser beam in a direction of travel including a directional component parallel to the contact surface between the distal ends.

### RELATED ART DOCUMENTS

### Patent Documents

Patent Document 1: Japanese Unexamined Patent Application Publication No. 2021-44883 (JP 2021-44883 A)

### SUMMARY OF THE INVENTION

### Problem to be Solved by the Invention

In such related art as described above, it is difficult to efficiently implement high-quality welding depending on the relationship between the beam diameter of the laser beam and the amount of movement in the direction of travel per loop scan (hereinafter sometimes simply referred to as “loop pitch”). For example, if the loop pitch is too large relative to the beam diameter of the laser beam, a molten pool cannot be properly maintained, which may result in reduced welding quality. If the loop pitch is too small relative to the beam diameter of the laser beam, the welding time and heat input per unit length of a welding target portion may be excessive.

Therefore, in one aspect, an object of the present disclosure is to efficiently implement high-quality welding regarding welding between coil pieces of a stator for a rotating electrical machine.

### Means for Solving the Problem

In one aspect, a method for manufacturing a stator for a rotating electrical machine is provided. The method includes: a step of bringing distal ends of one coil piece and another coil piece that form a stator coil of the rotating electrical machine into contact with each other; and a radiation step of emitting a laser beam with a wavelength of 0.6 μm or less toward one exposed side of a contact surface between the distal ends. The radiation step includes scanning the laser beam in a loop while moving the laser beam in a direction of travel including a directional component in which the exposed side extends. An amount of movement in the direction of travel per loop scan is equal to or less than a beam diameter of the laser beam.

### Effects of the Invention

In the one aspect, the present disclosure can efficiently implement high-quality welding regarding welding between coil pieces of a stator for a rotating electrical machine.

### BRIEF DESCRIPTION OF THE DRAWINGS

FIG. 1 is a sectional view schematically showing a sectional structure of a motor according to an embodiment.

FIG. 2 is a plan view of a stator core alone.

FIG. 3 is a diagram schematically showing a pair of coil pieces that is installed in the stator core.

FIG. 4 is a schematic front view of one coil piece.

FIG. 5 is a diagram showing joined distal ends of coil pieces and portions near the distal ends.

FIG. 6 is a diagram schematically showing a welding target portion as viewed from the radiation side.

FIG. 7 is a sectional view taken along line A-A in FIG. 5 passing through the welding target portion.

FIG. 8 is a diagram showing the relationship between the laser wavelength and the laser absorptivity of samples of various materials.

FIG. 9 is a diagram illustrating how the absorptivity changes during welding.

FIG. 10A is an illustration of a keyhole etc. when a green laser is used.

FIG. 10B is an illustration of a keyhole etc. when an infrared laser is used.

FIG. 11 is a diagram illustrating how the green laser is emitted according to a manufacturing method of an embodiment.

FIG. 11A is an illustration regarding laser beam scanning, illustrating the emission center of a laser beam.

FIG. 11B is an illustration regarding the laser beam scanning, illustrating how the laser beam is moved.

FIG. 12 is a diagram illustrating how the infrared laser is emitted according to a comparative example.

FIG. 13 is a sectional view taken along a welding direction on a contact surface according to the embodiment.

FIG. 14 is a sectional view taken along a welding direction on a contact surface according to the comparative example.

FIG. 15 shows an image of a lower end of a joint surface according to the embodiment.

FIG. 16 shows an image of a lower end of a joint surface according to the comparative example.

FIG. 17 is a diagram illustrating robustness against radial deviation of a radiation position.

FIG. 18 is a table showing a plurality of conditions (conditions 1 to 3) under which a test was conducted.

FIG. 19 is a graph showing the relationship between the wobbling diameter and the number of spatters for each condition.

FIG. 20 is a graph showing the relationships between the wobbling diameter and the joint area and weld depth.

FIG. 21 is a diagram showing a preferred welding speed for each Y-direction position (change profile of the welding speed according to the Y-direction position), with the abscissa representing the Y-direction position in a Y-direction and the ordinate representing the welding speed.

FIG. 22 is a diagram illustrating a wobbling pitch in the section from a Y-direction position P1 to a Y-direction position P2.

FIG. 23 is a diagram illustrating a wobbling pitch in the section from a Y-direction position P3 to a Y-direction position P5.

FIG. 24A is a diagram illustrating a first comparative example.

FIG. 24B is a diagram illustrating a problem of the first comparative example.

FIG. 25A is a diagram illustrating a second comparative example.

FIG. 25B is a diagram illustrating a problem of the second comparative example.

FIG. 26 is a flowchart schematically showing the flow of a method for manufacturing a stator of a motor.

FIG. 27 is a system configuration diagram of a manufacturing apparatus.

### MODES FOR CARRYING OUT THE INVENTION

Embodiments will be described in detail below with reference to the accompanying drawings. The dimensional ratios in the drawings are merely illustrative, and are not limited to these. The shapes etc. in the drawings may be partially exaggerated for convenience of description.

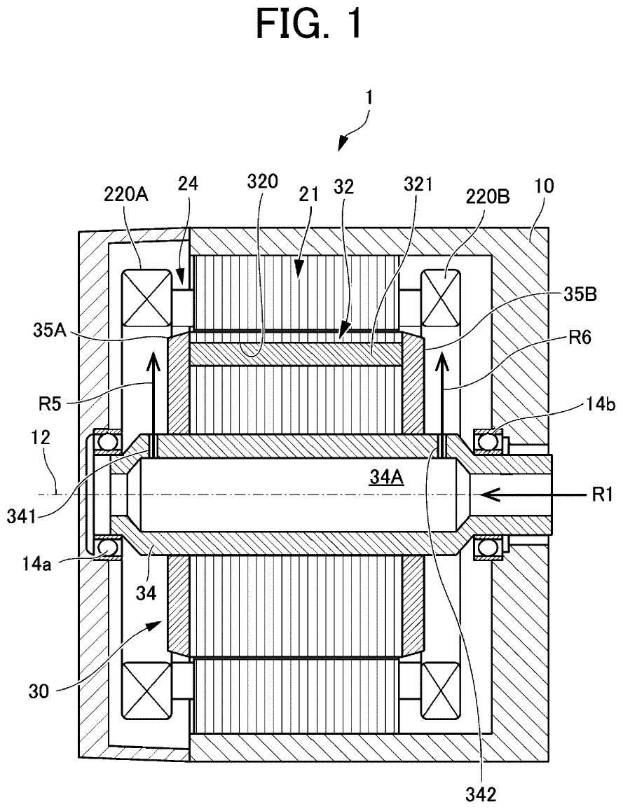

FIG. 1 is a sectional view schematically showing a sectional structure of a motor 1 (an example of a rotating electrical machine) according to an embodiment.

FIG. 1 shows a rotation axis 12 of the motor 1. In the following description, the axial direction refers to a direction in which the rotation axis (rotation center) 12 of the motor 1 extends, and the radial direction refers to a radial direction about the rotation axis 12. Therefore, the radially outer side and radially outward refer to a side away from the rotation axis 12, and the radially inner side and radially inward refer to a side toward the rotation axis 12. The circumferential direction corresponds to a rotation direction about the rotation axis 12.

The motor 1 may be a vehicle drive motor that is used in, for example, a hybrid electric vehicle or a battery electric vehicle. The motor 1 may be used for any other purposes.

The motor 1 is of an inner rotor type, and a stator 21 is provided so as to surround the radially outer side of a rotor 30. The radially outer side of the stator 21 is fixed to a motor housing 10.

The rotor 30 is disposed radially inward of the stator 21. The rotor 30 includes a rotor core 32 and a rotor shaft 34. The rotor core 32 is fixed to the radially outer side of the rotor shaft 34 and rotates with the rotor shaft 34. The rotor shaft 34 is rotatably supported by the motor housing 10 via bearings 14a, 14b. The rotor shaft 34 defines the rotation axis 12 of the motor 1.

The rotor core 32 is made of, for example, annular magnetic steel laminations. A permanent magnet 321 is inserted into a magnet hole 320 of the rotor core 32. The number, arrangement, etc. of permanent magnets 321 may be determined as appropriate. In a modification, the rotor core 32 may be made of a green compact obtained by pressing and compacting magnetic powder.

End plates 35A, 35B are attached to both sides in the axial direction of the rotor core 32. The end plates 35A, 35B may have a function to adjust an imbalance of the rotor 30 (function to eliminate the imbalance by being cut etc.) in addition to a support function to support the rotor core 32.

As shown in FIG. 1, the rotor shaft 34 has a hollow portion 34A. The hollow portion 34A extends along the entire axial length of the rotor shaft 34. The hollow portion 34A may function as an oil passage. For example, oil is supplied to the hollow portion 34A from its one axial end as shown by arrow R1 in FIG. 1, and the oil flows along the radially inner surface of the rotor shaft 34. The rotor core 32 can thus be cooled from the radially inner side. The oil flowing along the radially inner surface of the rotor shaft 34 may be ejected radially outward through oil holes 341, 342 formed in both ends of the rotor shaft 34 (arrows R5, R6) to cool coil ends 220A, 220B.

Although the motor 1 having a specific structure is shown in FIG. 1, the motor 1 may have any structure as long as it has a stator coil 24 (described later) joined by welding. Accordingly, for example, the rotor shaft 34 may not have the hollow portion 34A, or may have a hollow portion with a significantly smaller inside diameter than the hollow portion 34A. While a specific cooling method is disclosed in FIG. 1, the motor 1 may be cooled by any method. Therefore, for example, an oil introduction pipe inserted into the hollow portion 34A may be provided, or oil may be dripped from the radially outer side toward the coil ends 220A, 220B through an oil passage in the motor housing 10.

Although FIG. 1 shows the inner rotor motor 1 in which the rotor 30 is disposed inside the stator 21, the present disclosure may be applied to other types of motors. For example, the present disclosure may be applied to an outer rotor motor in which the rotor 30 is concentrically disposed outside the stator 21, or a dual-rotor motor in which the rotor 30 is disposed both outside and inside the stator 21.

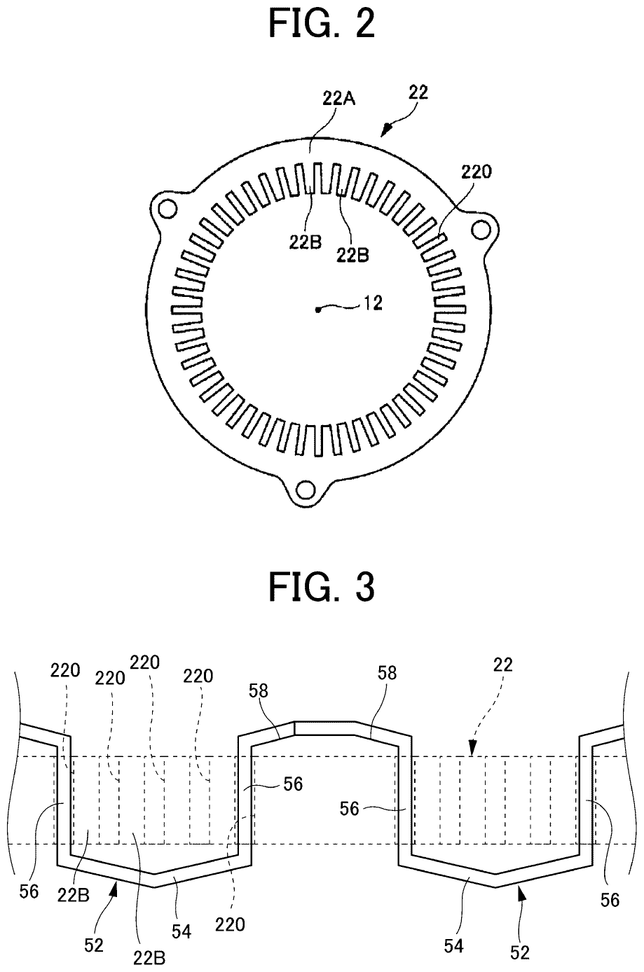

Next, the configuration related to the stator 21 will be described in detail with reference to FIG. 2 and the subsequent figures.

FIG. 2 is a plan view of a stator core 22 alone. FIG. 3 is a diagram schematically showing a pair of coil pieces 52 that is installed in the stator core 22. FIG. 3 shows the relationship between the pair of coil pieces 52 and slots 220 on the radially inner side of the stator core 22 shown opened out flat. In FIG. 3, the stator core 22 is shown by dashed lines, and part of the slots 220 is not shown.

The stator 21 includes the stator core 22 and the stator coil 24 (see FIG. 1).

The stator core 22 is made of, for example, annular magnetic steel laminations. In a modification, the stator core 22 may be made of a green compact obtained by pressing and compacting magnetic powder. The stator core 22 may be a segmented core segmented in the circumferential direction, or may be a core that is not segmented in the circumferential direction. A plurality of slots 220 in which the stator coil 24 is wound is formed in the radially inner side of the stator core 22. Specifically, as shown in FIG. 2, the stator core 22 includes an annular back yoke 22A and a plurality of teeth 22B extending radially inward from the back yoke 22A, and the slots 220 are formed between the plurality of teeth 22B in the circumferential direction. Although any number of slots 220 may be provided, 48 slots 220 are provided by way of example in the present embodiment.

The stator coil 24 includes a U-phase coil, a V-phase coil, and a W-phase coil (hereinafter referred to as “phase coils” when the phases U, V, and W are not distinguished from each other). The starting end of each phase coil is connected to an input terminal (not shown). The finishing end of each phase coil is connected to the finishing ends of the other phase coils to form a neutral point of the motor 1. That is, the stator coil 24 is connected in a star connection. However, the manner of connection of the stator coil 24 may be changed as appropriate according to the required motor characteristics etc. For example, the stator coil 24 may be connected in a delta connection instead of the star connection.

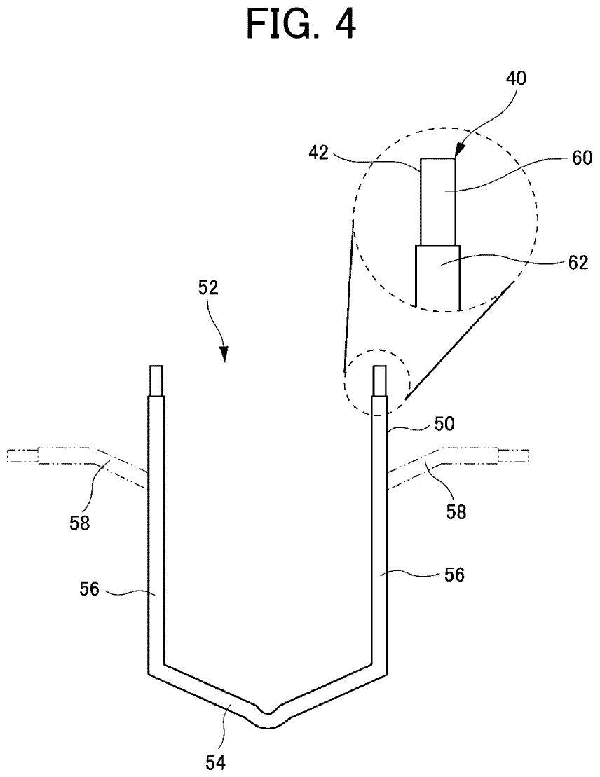

Each phase coil is formed by joining a plurality of coil pieces 52. FIG. 4 is a schematic front view of one coil piece 52. The coil pieces 52 are in the form of segment coils that are separate, easy-to-install units of phase coils (e.g. units each to be inserted into two slots 220). The coil piece 52 is formed by coating a linear conductor (rectangular wire) 60 having a rectangular cross section with an insulating coating 62. In the present embodiment, the linear conductor 60 is made of, for example, copper. In a modification, the linear conductor 60 may be made of a different conductor material such as iron.

Before being installed in the stator core 22, the coil piece 52 may be formed in a generally U-shape having a pair of straight portions 50 and a connecting portion 54 connecting the pair of straight portions 50. When installing the coil piece 52 in the stator core 22, the pair of straight portions 50 is inserted into the slots 220 (see FIG. 3). As shown in FIG. 3, the connecting portion 54 thus extends in the circumferential direction across a plurality of teeth 22B (and therefore a plurality of slots 220) at the other axial end of the stator core 22. Although the connecting portion 54 may extend across any number of slots 220, the connecting portion 54 extends across three slots 220 in FIG. 3. After being inserted into the slots 220, the straight portions 50 are bent at an intermediate position in the circumferential direction, as shown by long dashed double-short dashed lines in FIG. 4. Each straight portion 50 is thus turned into a leg portion 56 extending in the axial direction in the slot 220 and a crossover portion 58 extending in the circumferential direction at one axial end of the stator core 22.

In FIG. 4, the pair of straight portions 50 is bent away from each other. However, the present disclosure is not limited to this. For example, the pair of straight portions 50 may be bent toward each other. The stator coil 24 may also have a neutral point coil piece etc. that connects the finishing ends of the three-phase coils to form a neutral point.

A plurality of leg portions 56 of the coil pieces 52 shown in FIG. 4 is inserted into one slot 220 side by side in the radial direction. A plurality of crossover portions 58 extending in the circumferential direction is thus located side by side in the radial direction at the one axial end of the stator core 22. As shown in FIG. 3, the crossover portion 58 of one coil piece 52 protruding from one slot 220 and extending toward a first side in the circumferential direction (e.g., clockwise direction) is joined to the crossover portion 58 of another coil piece 52 protruding from another slot 220 and extending toward a second side in the circumferential direction (e.g., counterclockwise direction).

In the present embodiment, for example, six coil pieces 52 are installed in one slot 220. Hereinafter, these coil pieces 52 are also referred to as first turn, second turn, and third turn from outside to inside in the radial direction, with the outermost coil piece 52 in the radial direction being the first turn. In this case, the first turn coil piece 52 and the second turn coil piece 52 are joined at their distal ends 40 by a joining process described later, the third turn coil piece 52 and the fourth turn coil piece 52 are joined at their distal ends 40 by the joining process described later, and the fifth turn coil piece 52 and the sixth turn coil piece 52 are joined at their distal ends 40 by the joining process described later.

Although each coil piece 52 is covered with the insulating coating 62 as described above, the insulating coating 62 is removed only from its distal ends 40. This is to ensure electrical connection with other coil pieces 52 at the distal ends 40.

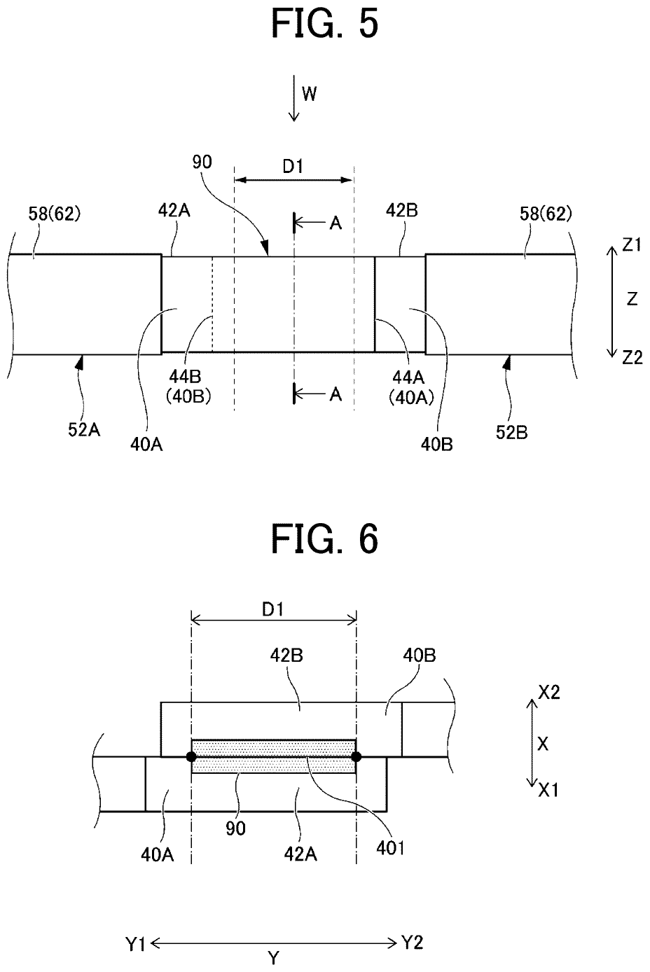

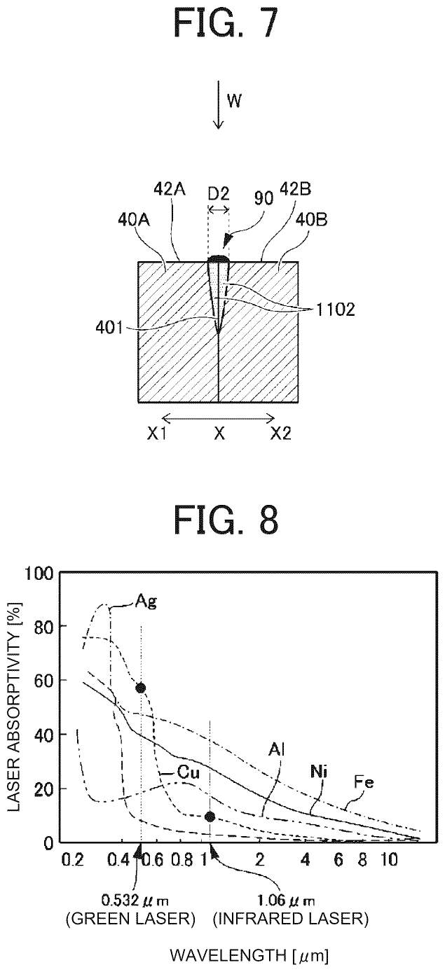

FIG. 5 is a diagram showing the joined distal ends 40 of the coil pieces 52 and the portions near the joined distal ends 40. FIG. 5 schematically shows a circumferential range D1 of a welding target portion 90. FIG. 6 is a diagram schematically showing the welding target portion 90 as viewed from the radiation side. FIG. 7 is a sectional view taken along line A-A in FIG. 5 passing through the welding target portion 90. In FIG. 7, the range of a molten pool formed during welding is schematically shown by hatched areas 1102. FIG. 8 is a diagram showing the relationship between the laser wavelength and the laser absorptivity of samples of various materials.

The Z direction along the axial direction is defined in FIG. 5. Hereinafter, for convenience of description, “upper” refers to the Z1 side in the Z-direction (that is, the radiation side from which a laser beam is emitted), and “lower” refers to the Z2 side in the Z-direction. The X-direction along the radial direction and the X1 and X2 sides in the X-direction are defined in FIG. 6.

When joining the distal ends 40 of the coil pieces 52, the distal ends 40 of one coil piece 52 and another coil piece 52 are brought into contact with each other in the radial direction so as to overlap each other in the view shown in FIG. 5 (as viewed in the radial direction). Hereinafter, for convenience of description, the configurations related to the one coil piece 52 are sometimes denoted by signs with the letter “A” at the end, like distal end 40A, and the configurations related to the another coil piece 52 are sometimes denoted by signs with the letter “B” at the end, like distal end 40B, in order to distinguish them from each other. In another embodiment, the distal ends 40 may cross each other in an X-shape. In this case, each of the distal ends 40 may be cut so that there is no protruding portion in the upper part of the X-shape.

In this case, the welding target portion 90 extends linearly along a contact surface 401 as shown by the range D1 in FIG. 6. That is, the welding target portion 90 extends linearly along the range D1 in the Y-direction with a width of a range D2 in the X-direction shown in FIG. 7, as viewed from the radiation side from which a laser beam is emitted (see arrow W in FIG. 5). In the present embodiment, the contact surface 401 has a rectangular shape surrounded by axial-direction outer end faces 42A, 42B and extending-direction end faces 44A, 44B as viewed in the radial direction. However, the contact surface 401 may have other shapes.

In the present embodiment, the welding target portion 90 is set along the upper side formed by the axial-direction outer end faces 42A, 42B of both distal ends 40 (exposed upper side out of the four sides of the rectangle) in the view shown in FIG. 5 (as viewed in the radial direction). In the present embodiment, the welding target portion 90 extends in the horizontal direction. However, depending on other possible shapes of the distal ends 40, the welding target portion 90 may extend in a C-shape curved downward or may be in other shapes in the view shown in FIG. 5 (as viewed in the radial direction). In the example shown in FIGS. 5 and 6, the axial-direction outer end faces 42A, 42B extend in an XY plane. However, the axial-direction outer end faces 42A, 42B may be tilted with respect to the XY plane.

In the present embodiment, the joining method for joining the distal ends 40 of the coil pieces 52 is welding. In the present embodiment, the welding method is laser welding using a laser beam source as a heat source, rather than arc welding represented by TIG welding. The axial length of the coil ends 220A, 220B can be reduced by using the laser welding instead of the TIG welding. That is, in the case of the TIG welding, the distal ends of the coil pieces to be brought into contact with each other need to be bent axially outward so as to extend in the axial direction. In the case of the laser welding, however, such bending is not necessary, and as shown in FIG. 5, welding can be implemented with the distal ends 40 of the coil pieces 52 to be brought into contact with each other extending in the circumferential direction. The axial length of the coil ends 220A, 220B can thus be reduced compared to the case where the distal ends 40 of the coil pieces 52 to be brought into contact with each other are bent axially outward so as to extend in the axial direction.

In the laser welding, as schematically shown in FIG. 5, a welding laser beam is applied to the welding target portion 90 in the two distal ends 40 that are in contact with each other. The radiation direction (propagation direction) of the laser beam is substantially parallel to the axial direction, and is a direction from outside in the axial direction toward the axial-direction outer end faces 42 of the two distal ends 40 that are in contact with each other (including the exposed side of the contact surface 401). In the case of the laser welding, heating can be locally performed. Therefore, only the distal ends 40 and the portions near the distal ends 40 can be heated, and damage (carbonization) etc. to the insulating coatings 62 can be effectively reduced. As a result, the plurality of coil pieces 52 can be electrically connected while maintaining appropriate insulation performance.

FIG. 8 is a diagram showing the relationship between the laser wavelength and the laser absorptivity (hereinafter sometimes simply referred to as “absorptivity”) of samples of various materials. FIG. 8 shows characteristics of the samples of various materials, namely copper (Cu), aluminum (Al), silver (Ag), nickel (Ni), and iron (Fe), where the abscissa represents the wavelength λ, and the ordinate represents the absorptivity.

Copper that is a material of the linear conductor 60 of the coil piece 52 has an absorptivity as low as about 10% for an infrared laser (laser with a wavelength of 1064 nm) that is commonly used in the laser welding, as shown by a black circle at the intersection with a dotted line of λ2=1.06 μm in FIG. 8. That is, in the case of the infrared laser, most of the laser beam is reflected and not absorbed by the coil piece 52. Therefore, a relatively high heat input is required to obtain a required joint area between the coil pieces 52 to be joined, and welding may become unstable due to the large influence of the heat.

In view of this, in the present embodiment, a green laser is used instead of the infrared laser. The “green laser” is a concept including not only a laser with a wavelength of 532 nm, that is, an SHG (Second Harmonic Generation: second harmonic) laser but also lasers with wavelengths close to 532 nm. In a modification, a laser with a wavelength of 0.6 um or less that does not belong to the category of the green laser may be used. The wavelength of the green laser can be obtained by, for example, converting a fundamental wavelength generated by a YAG laser or a YVO4 laser through an oxide single crystal (e.g., LBO: lithium triborate).

Copper that is a material of the linear conductor 60 of the coil piece 52 has an absorptivity as high as about 50% for the green laser, as shown by a black circle at the intersection with a dotted line of λ1=0.532 μm in FIG. 8. Therefore, according to the present embodiment, a required joint area between the coil pieces 52 can be obtained with a smaller heat input than in the case of using the infrared laser.

The characteristic that the absorptivity is higher for the green laser than for the infrared laser is remarkable in copper as shown in FIG. 8, but can be observed not only in copper but also in many of other metal materials. Therefore, welding with the green laser may be implemented even when the linear conductor 60 of the coil piece 52 is made of a material other than copper.

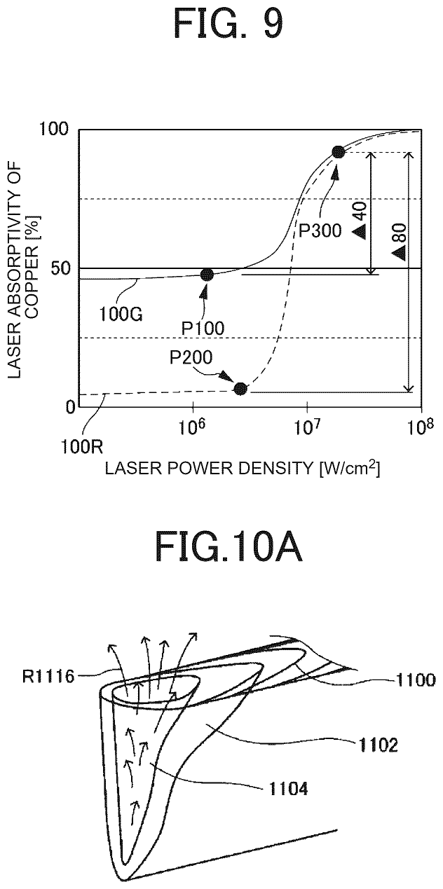

FIG. 9 is a diagram illustrating how the absorptivity changes during welding. FIG. 9 shows a characteristic 100G for the green laser and a characteristic 100R for the infrared laser, where the abscissa represents the laser power density, and the ordinate represents the laser absorptivity of copper.

FIG. 9 shows points P100, P200 at which copper starts to melt and a point P300 at which a keyhole is formed in the case of the green laser and the infrared laser. As shown by the points P100, P200 in FIG. 9, it can be seen that copper can start to melt at a lower laser power density with the green laser than with the infrared laser. It can also be seen that, due to the difference in absorptivity described above, the difference between the absorptivity at the point P300 at which a keyhole is formed and the absorptivity at the start of radiation (that is, the absorptivity when the laser power density is 0) is smaller for the green laser than for the infrared laser. Specifically, a change in absorptivity during welding is about 80% for the infrared laser, while a change in absorptivity during welding is about 40% for the green laser, which is about half the change for the infrared laser.

As described above, in the case of the infrared laser, the change (increase) in absorptivity during welding is as relatively large as about 80%. Therefore, the keyhole is more likely to become unstable, and variations in weld depth and weld width and disturbance of a molten pool (e.g., spatter etc.) are more likely to occur. In the case of the green laser, on the other hand, the change (increase) in absorptivity during welding is as relatively small as about 40%. Therefore, the keyhole is less likely to become unstable, and variations in weld depth and weld width and disturbance of a molten pool (e.g., spatter etc.) are less likely to occur. Spatter is metal droplets etc. expelled by irradiation with a laser etc.

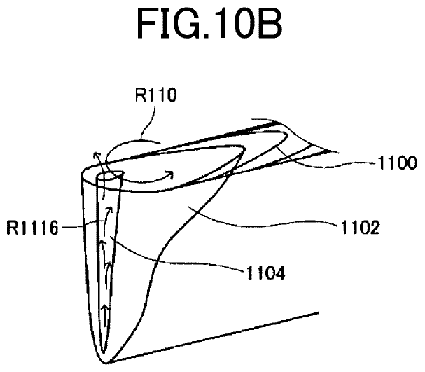

In the case of the infrared laser, the absorptivity is low as described above. It is therefore common to compensate for the low absorptivity by making the beam diameter relatively small (e.g., φ0.075 mm). This also contributes to the keyhole becoming unstable. FIG. 10B is an illustration of a keyhole etc. when the infrared laser is used, where 1100 indicates a weld bead, 1102 indicates a molten pool, and 1104 indicates a keyhole. Arrow R1116 schematically shows how gas is released. Arrow R110 schematically shows how the radiation position of the infrared laser is moved due to the small beam diameter. In the case of the infrared laser, the absorptivity is low and it is difficult to make the beam diameter relatively large, as described above. Therefore, a relatively long movement trajectory of the radiation position including meandering (relatively long continuous radiation time) tends to be required to obtain a required melting width.

On the other hand, in the case of the green laser, the absorptivity is relatively high as described above, and it is possible to make the beam diameter relatively large (e.g., (φ0.15 mm or more). A large, stable keyhole can thus be formed. As a result, gas release is improved, and spatter etc. can be effectively reduced. FIG. 10A is an illustration of a keyhole etc. when the green laser is used. The definitions of the signs are as described above with reference to FIG. 10B. In the case of the green laser, it can be easily visually understood from FIG. 10A how a keyhole is stabilized and gas release is improved due to the increased beam diameter. In the case of the green laser, unlike the infrared laser, the absorptivity is relatively high and it is possible to make the beam diameter relatively large, as described above. Therefore, the movement trajectory of the radiation position (radiation time) required to obtain a required melting width (see the radial range D2 of the welding target portion 90 shown in FIG. 7) can be made relatively short (small) (described later).

A manufacturing method that efficiently implements high-quality welding using such a green laser will be disclosed below.

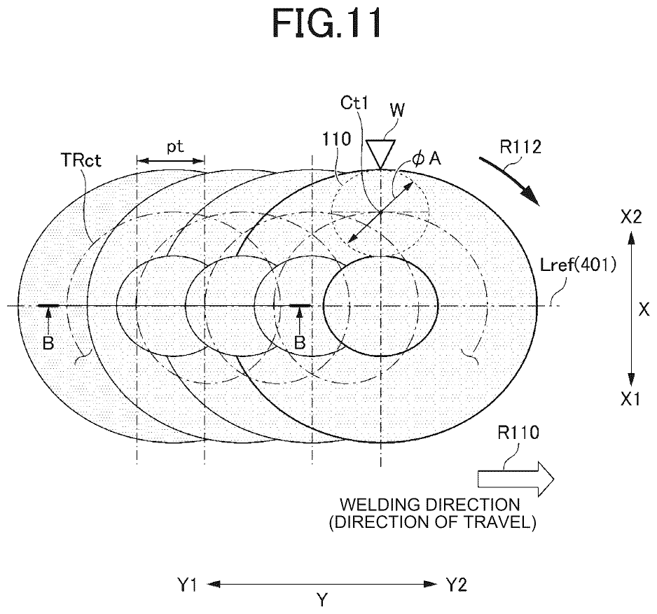

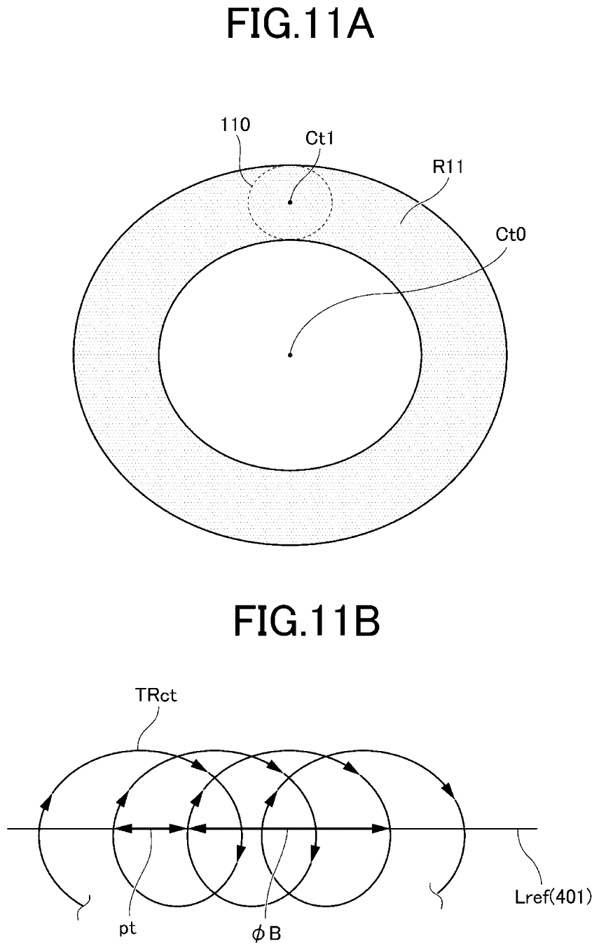

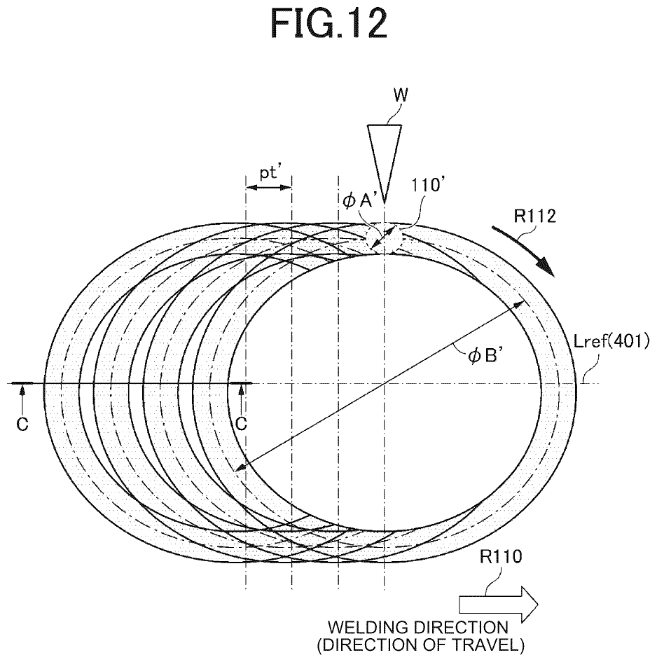

FIG. 11 is a diagram illustrating how the green laser is emitted according to the manufacturing method of the present embodiment. FIG. 11A is an illustration regarding laser beam scanning, illustrating the emission center Ct0 of a laser beam. FIG. 11B is an illustration regarding the laser beam scanning, illustrating how the laser beam is moved. FIG. 12 is a diagram illustrating how the infrared laser is emitted according to a comparative example. FIGS. 11 and 12 are schematic diagrams as viewed in a laser radiation direction. Irradiation regions in the welding target portion 90 that are irradiated with the laser (or portions to be irradiated with the laser) at a certain point during welding are schematically shown by hatched areas. In FIGS. 11 and 12, circles 110, 110′ representing a laser beam indicate irradiation ranges at a certain point during welding, and are shown with beam diameters φA, φA′. In FIGS. 11 and 12, a line Lref represents the contact surface 401 (upper side of the contact surface 401).

The manufacturing method of the present embodiment includes scanning a laser beam in a loop (see arrow R112) while moving the laser beam in a welding direction (direction of travel), as schematically shown in FIG. 11. The direction of travel is a direction along the upper side of the contact surface 401 described above (i.e., a direction parallel to the upper side). The direction of travel may be slightly tilted with respect to this side due to an error etc. In the following description, “on the contact surface 401” refers to a portion that forms the upper side of the contact surface 401 (see the line Lref).

The “loop” is a concept that includes not only a circular shape but also any shape that can form a loop, such as an elliptical shape. It need not necessarily be completely closed, and may be a continuous spiral shape. In the present embodiment, as an example, the loop is such a shape that circles are spirally connected. Such a loop can be implemented by, for example, using a laser beam that is emitted (scanned) from an emitting portion so as to follow a circular trajectory a certain number of times per unit time. In FIG. 11A, the circular trajectory (scan) of the laser beam when the laser beam (emitting portion) is not moved is schematically shown by a hatched area R11. When the laser beam is not moved, the circle 110 rotates about the emission center Ct0 (=center of the circular trajectory), and the circle 110 follows a circular path about the emission center Ct0 (=center of the circular trajectory). In this case, a loop-shaped trajectory of the circle 110 can be implemented by linearly moving the emission center Ct0 (=center of the circular trajectory). At this time, the direction of travel along the upper side of the contact surface 401 can be implemented by moving the emission center Ct0 of the laser beam on the contact surface 401. In FIGS. 11 and 11B, a long dashed short dashed line TRct represents the trajectory of the center Ct1 of the laser beam (arrows indicate the direction of travel) when the laser beam is moved in this manner (moved linearly along the upper side of the contact surface 401).

The diameter of the circle of the loop (hereinafter also referred to as “wobbling diameter φB”) may be any desired value, but its preferable range will be described later. For example, the wobbling diameter φB may be larger than the beam diameter φA of the laser beam.

In the present embodiment, the amount of movement in the direction of travel per loop scan (hereinafter also referred to as “wobbling pitch pt”) is equal to or smaller than the beam diameter φA of the laser beam. Regarding “per loop scan,” one loop scan refers to one rotation from one phase of a circle to the same phase. An irradiation range for one loop and an irradiation range for the subsequent loop can thus be set as ranges that are continuous in the welding direction on the contact surface 401, as shown in FIG. 11. For example, when the wobbling pitch pt is ½ the beam diameter φA of the laser beam, the irradiation range for one loop and the irradiation range for the subsequent loop overlap each other by ½ the beam diameter φA on the contact surface 401.

In this case, a molten pool formed in the welding target portion 90 can be moved in the welding direction on the contact surface 401 while being maintained. That is, according to the present embodiment, the molten pool can be moved in the welding direction on the contact surface 401 by the wobbling pitch pt for each loop scan while being maintained.

The wobbling pitch pt is constant for one welding target portion 90. However, the wobbling pitch pt may be variable. The beam diameter φA may be the size at an emitting end. In this case, the beam diameter φA represents the Gaussian beam diameter (1/e²). In the case of an elliptical beam, however, the length of the major axis or minor axis of the elliptical spot may be used instead.

In the present embodiment, the beam diameter φA is preferably φ0.1 mm or more, and more preferably φ0.15 mm or more. By increasing the beam diameter φA, the wobbling pitch pt can also be increased under the condition that the wobbling pitch pt is equal to or smaller than the beam diameter φA of the laser beam. As described above with reference to FIG. 10A and as will be described below in comparison with a comparative example, the movement trajectory (radiation time) required to obtain a required melting width can thus be made relatively short, so that efficient welding can be implemented.

In the present embodiment, the laser beam is continuously emitted with a laser output of 3.0 kW or more for a plurality of loop scans. For example, the laser beam may be continuously emitted to one entire welding target portion 90. In this case, the output itself may be lower, but it is easier to maintain a molten pool, and the welding time can be reduced, compared to radiation using pulsed oscillation.

In the comparative example shown in FIG. 12, as described above, the beam diameter φA′ is relatively small, for example φ0.08 mm, because an infrared laser is used. The wobbling pitch pt′ is 0.1 mm. In this case, as shown in FIG. 12, the irradiation ranges for the loops are discontinuous in the welding direction on the contact surface 401.

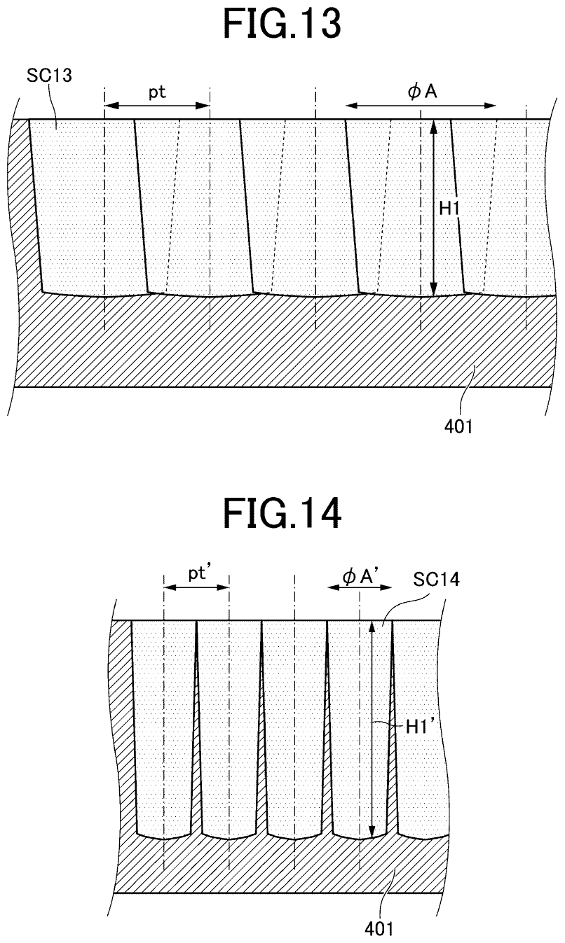

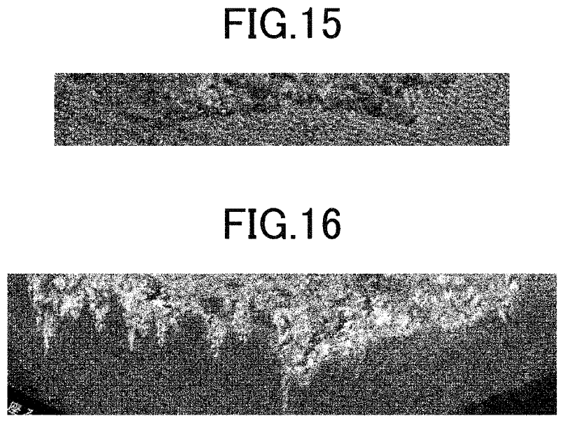

FIG. 13 is a sectional view taken along line B-B in FIG. 11 according to the present embodiment (sectional view taken along the welding direction on the contact surface 401), and FIG. 14 is a sectional view taken along line C-C in FIG. 12 according to the comparative example (sectional view taken along the welding direction on the contact surface 401). These figures are schematic diagrams showing the state of the joint surface when cut along the contact surface 401. In FIGS. 13 and 14, the joint surface is schematically shown by hatched areas SC13, SC14. The joint surface refers to a portion of the contact surface 401 that has been joined due to welding. FIGS. 15 and 16 show images of part of the joint surface (lower end of the joint surface) when cut along the contact surface 401. FIG. 15 shows an image according to the present embodiment, and FIG. 16 shows an image according to the comparative example. As an example, the conditions for the present embodiment shown in FIG. 15 are as follows: beam diameter φA =0.27 mm, wobbling diameter φB=0.6 mm, and wobbling pitch pt=0.2 mm. The conditions for the comparative example shown in FIG. 14 are as follows: beam diameter φA′=0.08 mm, wobbling diameter φB′=0.7 mm, and wobbling pitch pt′=0.1 mm.

In the comparative example, the irradiation ranges for the loops are discontinuous in the welding direction on the contact surface 401, as described above. Therefore, the height H1′ of the lower end of the joint surface (weld depth H1′) varies greatly along the welding direction, as shown in FIGS. 14 and 16. That is, there is a portion where the height H1′ suddenly becomes small (where the weld depth suddenly becomes shallow) between the irradiation ranges for the loops. This is disadvantageous in that the joint area (area of the joint surface) tends to be insufficient. One possible solution to this is to further reduce the wobbling pitch pt′ so that the irradiation ranges for the loops overlap each other. However, this solution may cause other disadvantages such as excessive welding time or excessive heat input.

According to the present embodiment, on the other hand, as described above, the irradiation ranges for the loops are continuous in the welding direction on the contact surface 401. This can reduce or prevent the above disadvantage of the comparative example. That is, the height H1 of the lower end of the joint surface (weld depth H1) does not vary greatly along the welding direction but remains substantially constant, as shown in FIGS. 13 and 15. Since the beam diameter φA is relatively large, the irradiation ranges for the loops can still be continuous even when the wobbling pitch pt is increased. Therefore, the welding time and heat input can be reduced (efficiency can be improved). In this regard, in the present embodiment, the wobbling pitch pt may be ¼ or more of the beam diameter φA of the laser beam, more preferably ⅓ or more of the beam diameter φA of the laser beam, and most preferably ½ or more of the beam diameter φA of the laser beam under the condition that the beam diameter φA of the laser beam is equal to or less than the beam diameter φA of the laser beam.

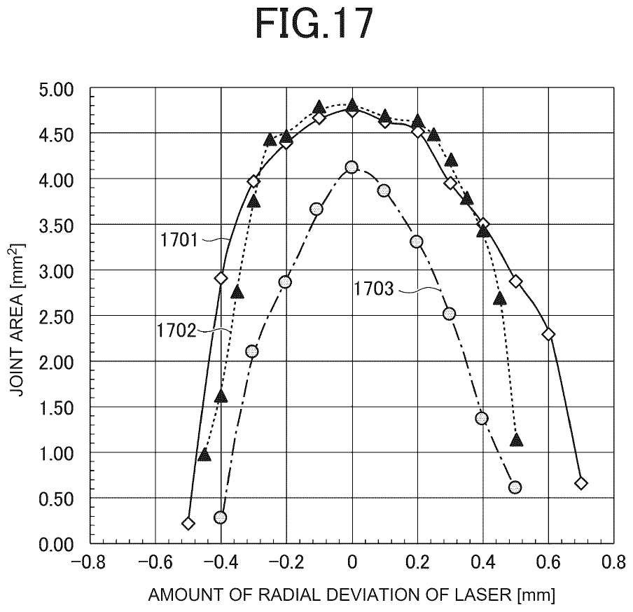

FIG. 17 is a diagram illustrating robustness against radial deviation of the radiation position. FIG. 17 shows characteristic curves 1701, 1702, and 1703 for three different methods, with the abscissa representing the amount of radial deviation of the laser and the ordinate representing the joint area. The amount of radial deviation of the laser represents the radial position of the center of the irradiation region with the position on the contact surface 401 being “0” and a negative sign representing the radially inner side.

The characteristic curve 1701 represents the present embodiment, the characteristic curve 1702 represents a first comparative example, and the characteristic curve 1703 represents a second comparative example. The first comparative example corresponds to the comparative example described with reference to FIG. 12 etc. In the first comparative example, a beam diameter φA′=0.08 mm and a wobbling diameter φB′=0.7 mm. In the second comparative example, the green laser is used, but unlike the present embodiment, the scanning method is linear scanning. That is, in the second comparative example, the green laser is scanned linearly in the welding direction on the contact surface 401. The condition for the second comparative example is as follows: beam diameter=0.293 mm. The conditions for the present embodiment are as follows: beam diameter φA of 0.27 mm and wobbling diameter φB of 0.6 mm.

As shown in FIG. 17, the second comparative example has the lowest robustness against radial deviation of the radiation position. For example, a radially inward deviation of 0.2 mm would reduce the joint area to 3 mm² or less. The joint area for the amount of deviation=0 is significantly greater than 4 mm². On the other hand, the present embodiment and the first comparative example have relatively high robustness against radial deviation in the radiation position. Even a radially inward or radially outward deviation of 0.2 mm would not reduce the joint area to 3 mm² or less. It can be seen that the present embodiment has higher robustness than the first comparative example in the regions corresponding to radially inward and outward deviations of 0.4 mm or more.

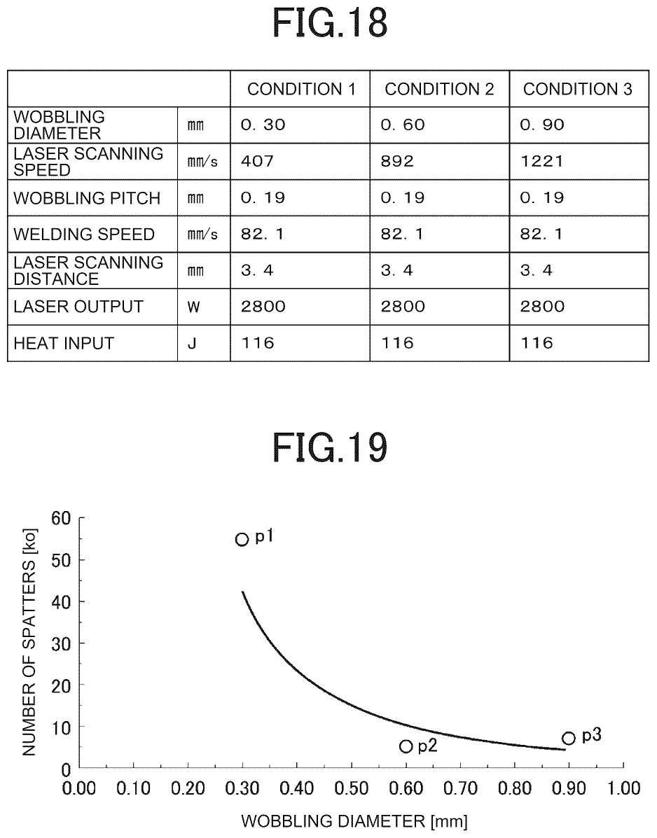

Next, a preferred range of the wobbling diameter φB in the present embodiment will be described based on test results with reference to FIGS. 18 to 20.

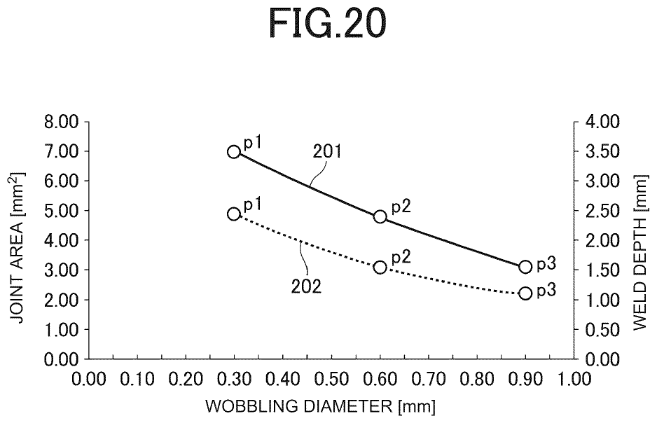

FIG. 18 is a table showing a plurality of conditions (conditions 1 to 3) under which the test was conducted. FIG. 19 is a graph showing the relationship between the wobbling diameter φB and the number of spatters for each condition, and FIG. 20 is a graph showing the relationships between the wobbling diameter φB and the joint area and weld depth. In FIG. 20, a graph 201 is for the weld area and a graph 202 is for the weld depth. In FIGS. 19 and 20, a plot p1 is for the condition 1, a plot p2 is for the condition 2, and a plot p3 is for the condition 3.

As shown in FIG. 18, for the conditions 1 to 3, the laser scanning speed is adjusted so that the heat input is the same. In FIG. 18, the laser scanning speed corresponds to the length of the radiation trajectory (length along the loop-shaped trajectory) of the laser beam per unit time. The welding speed is the distance by which the radiation position of the laser beam is moved per unit time. For example, the welding speed is a value obtained by dividing the distance by which the radiation position of the laser beam is moved over a certain period of time (distance by which the radiation position of the laser beam is moved in the welding direction on the contact surface 401) by this period of time. Common conditions (fixed conditions) for all the conditions are as follows: a green laser is used, beam diameter φA=0.273 mm, and the output distribution density is a Gaussian distribution.

As shown in FIG. 19, the larger the wobbling diameter φB, the more stable the molten pool and the less the number of spatters. Like the principle described above with reference to FIGS. 10A and 10B, when the wobbling diameter φB is relatively small, a keyhole is more likely to become unstable and disturbance of a molten pool (e.g., spatter etc.) is more likely to occur.

As shown in FIG. 20, it can be seen that, when the heat input is the same, the weld depth (penetration depth) increases as the wobbling diameter φB decreases. Similarly, it can be seen that, when the amount of heat is the same, the joint area increases as the wobbling diameter φB decreases.

As described above, a larger wobbling diameter φB is more advantageous from the viewpoint of reducing the number of spatters, but a smaller wobbling diameter φB is more advantageous from the viewpoint of increasing the weld depth and the joint area. Therefore, the preferred range of the wobbling diameter φB may be adjusted in view of these trade-offs. For example, when the wobbling diameter φB is less than φ0.4, the number of spatters may increase sharply as the wobbling diameter φB decreases. In view of this, the wobbling diameter φB may be preferably set to φ0.4 mm or more. When the wobbling diameter φB is larger than 00.75 mm, the joint area becomes relatively small. Therefore, the wobbling diameter φB may be preferably set to 00.75 mm or less. In this case, the wobbling diameter φB is between 1.46 times and 2.74 times the beam diameter φA of the laser beam. Therefore, the wobbling diameter φB may be adjusted between 1.4 times and 2.8 times the beam diameter φA of the laser beam.

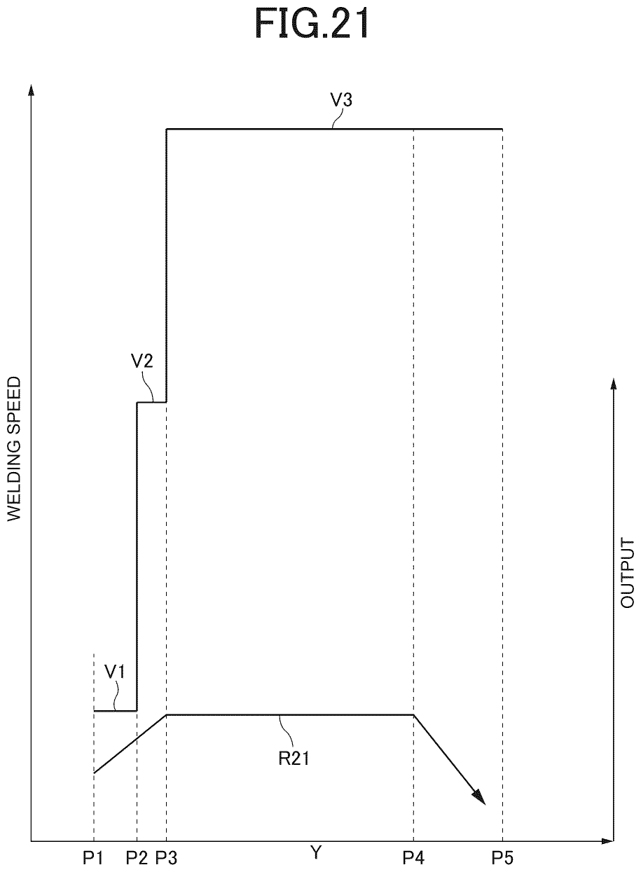

Next, a change profile of a preferred welding speed according to the present embodiment will be described with reference to FIGS. 21 to 25.

FIG. 21 is a diagram showing a preferred welding speed for each Y-direction position (change profile of the welding speed according to the Y-direction position), with the abscissa representing the Y-direction position in the Y-direction and the ordinate representing the welding speed. The positive side of the abscissa corresponds to the Y2 side described above. In this example, the Y1 side of the welding target portion 90 (see FIG. 6) is a welding start position, and the emission center Ct0 of the laser beam (see FIG. 11A) is moved from the Y1 side toward the Y2 side during welding. FIG. 21 shows preferred laser output for each Y-direction position (change profile of the laser output according to the Y-direction position) as a waveform R21, in addition to the change profile of the welding speed. In FIG. 21, a Y-direction position PI indicates a radiation start position, and a Y-direction position P5 indicates a radiation end position. The section from the Y-direction position P1 to the Y-direction position P5 corresponds to the range D1 described above with reference to FIGS. 5 and 6.

In the present embodiment, the welding speed is lowest at the start of radiation and is then increased. In the example shown in FIG. 21, the welding speed=V1 in the section from the Y-direction position P1 to a Y-direction position P2, the welding speed=V2 in the section from the Y-direction position P2 to a Y-direction position P3, and the welding speed=V3 in the section from the Y-direction position P3 to the Y-direction position P5, where V1<V2<V3.

The welding speed V1 is preferably significantly less than 80 mm/s. The welding speed V1 is, for example, in the range of 5 to 35 mm/s, and may be about 20 mm/s. The welding speed V3 is preferably 80 mm/s or more, and may be, for example, about 100 mm/s. In this case, the welding speed V2 may be an intermediate value between the welding speed V1 and the welding speed V3 (=(V1+V3)/2).

The section from the Y-direction position P1 to the Y-direction position P2 is preferably shorter than the section from the Y-direction position P3 to the Y-direction position P5, and is more preferably shorter than the section from the Y-direction position P3 to a Y-direction position P4.

The section from the Y-direction position P1 to the Y-direction position P2 is preferably less than 20% of the range D1, and more preferably 10% or less of the range D1. The section from the Y-direction position P2 to the Y-direction position P3 may be shorter than the section from the Y-direction position P1 to the Y-direction position P2.

The laser output is preferably highest in the section from the Y-direction position P3 to the Y-direction position P4. For example, as shown in FIG. 21, the laser output may be gradually increased from the Y-direction position P1 and may be maintained at a constant value in the section from the Y-direction position P3 to the Y-direction position P4. The laser output may then be reduced toward 0 (output off) using the section from the Y-direction position P4 to the Y-direction position P5. In this case, the laser output is maximized in the section from the Y-direction position P3 to the Y-direction position P4 out of the section with the welding speed V3, so that the main part of the welding target portion 90 can be welded with high quality in a short time.

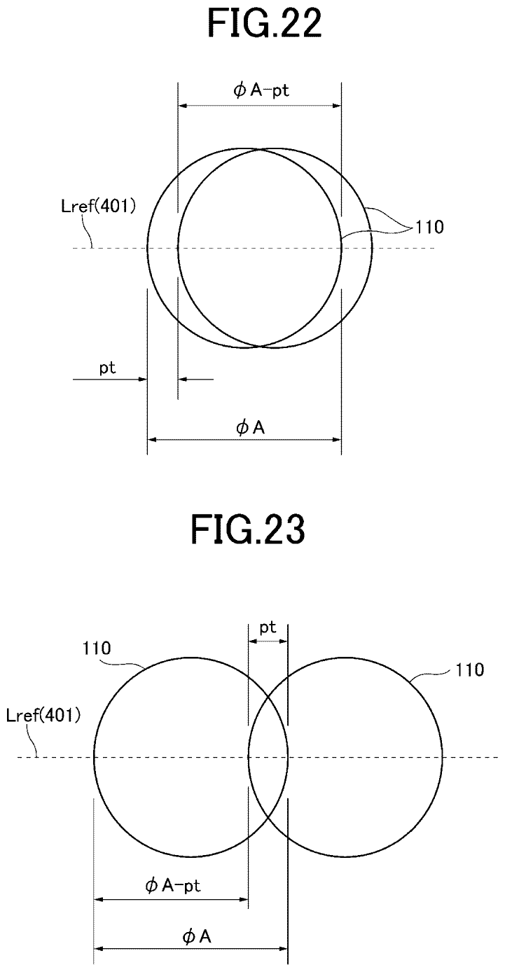

FIG. 22 is a diagram illustrating the wobbling pitch pt in the section from the Y-direction position P1 to the Y-direction position P2 (wobbling pitch pt at the welding speed V1) (example of the “first amount of movement”). FIG. 23 is a diagram illustrating the wobbling pitch pt in the section from the Y-direction position P3 to the Y-direction position P5 (wobbling pitch pt at the welding speed V3) (example of the “second amount of movement”).

FIGS. 22 and 23 each schematically show two circles 110 (see FIG. 11) each representing the laser beam on the line Lref (contact surface 401) shown in FIG. 11. The distance in the Y-direction between these two circles 110 corresponds to the wobbling pitch pt. It is herein assumed that the laser scanning speed is constant in the entire section from the Y-direction position P1 to the Y-direction position P5. Comparison between FIG. 22 and FIG. 23 shows that, as the welding speed increases, the wobbling pitch pt increases accordingly. On the other hand, as the welding speed increases, the overlap ratio of the two circles 110 (area of overlapping portion/area of circle×100) decreases accordingly. The welding speed V3 may be set so that the overlap ratio of the two circles 110 (area of overlapping portion/area of circle×100) is preferably 15% or more and 20% or less.

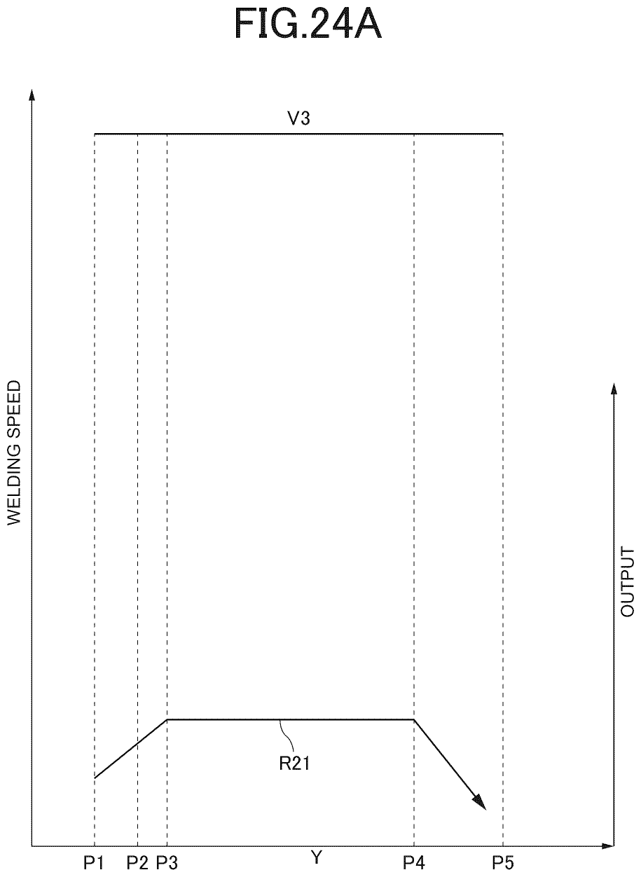

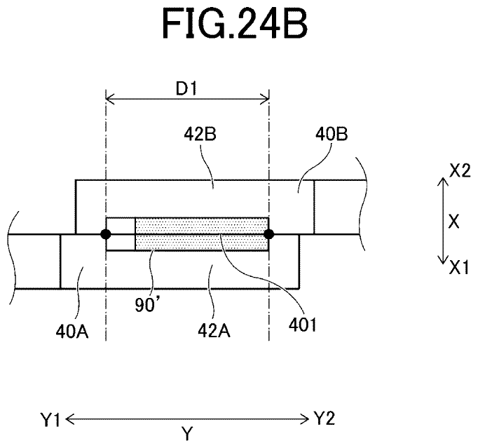

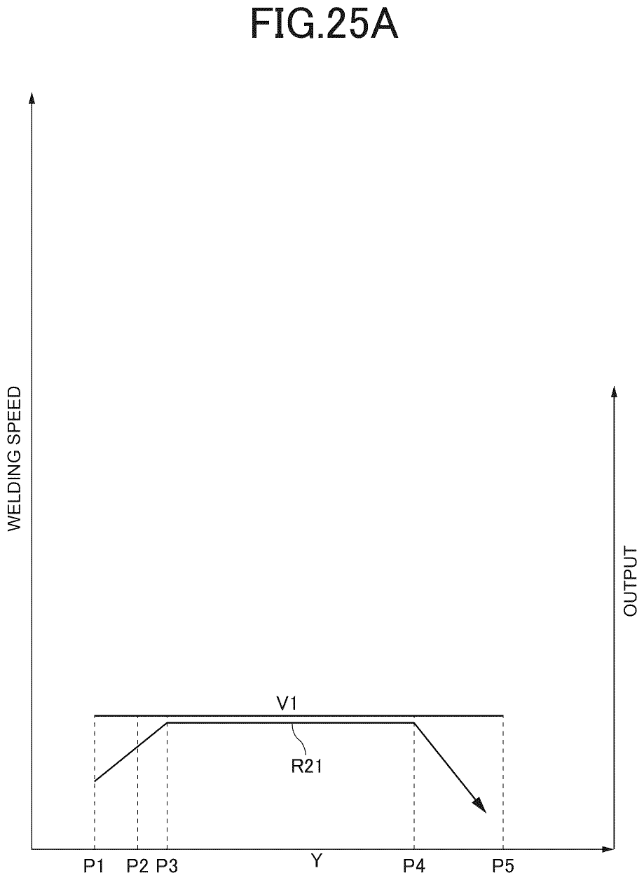

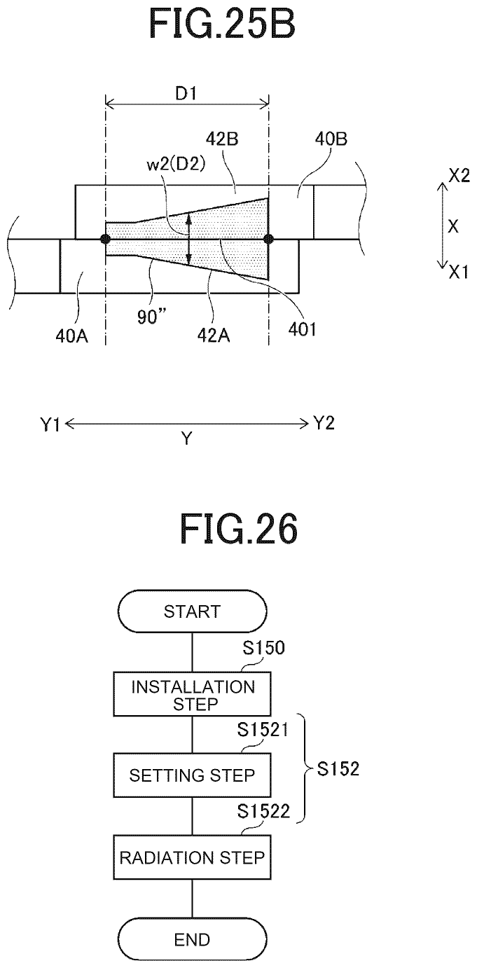

Effects of the change profile of the welding speed of the present embodiment described above with reference to FIG. 21 etc. will be described with reference to FIGS. 24A to 25B.

FIGS. 24A and 24B are diagrams illustrating the first comparative example, and FIG. 24B is a diagram illustrating a problem of the first comparative example. FIGS. 25A and 25B are diagrams illustrating the second comparative example, and FIG. 25B is a diagram illustrating a problem of the second comparative example. FIGS. 24A and 25A are diagrams each showing a preferred welding speed for each Y-direction position (change profile of the welding speed according to the Y-direction position), with the abscissa representing the Y-direction position in the Y-direction and the ordinate representing the welding speed, as in FIG. 21 described above according to the present embodiment. FIGS. 24B and 25B are diagrams each schematically showing a welding target portion 90′ or 90″ as viewed from the radiation side, as in FIG. 6 described above according to the present embodiment.

In the first comparative example, as shown in FIG. 24A, the welding speed is constant at a relatively high speed (=welding speed V3) in the entire section from the Y-direction position P1 to the Y-direction position P5.

In this case, the laser beam is moved in the Y-direction at a relatively high speed before the molten pool becomes large enough at the welding start position (Y-direction position P1), so that the laser beam tends to be directed to the area outside the molten pool. For example, when the laser beam is moved from the Y1 side toward the Y2 side, the laser beam tends to be directed to the area outside the molten pool on the Y2 side. In this case, as schematically shown in FIG. 24B, a defect tends to occur at the welding start position (Y-direction position P1). For example, at the welding start position (Y-direction position P1), the material (individual) of the irradiated portion of the distal ends 40 of the coil pieces 52 is likely to be blown away, so that a depression (represented by an unhatched area in FIG. 24B) tends to be formed.

According to the present embodiment, on the other hand, as described above, the relatively low welding speed V1 is used in the section from the Y-direction position P1 to the Y-direction position P2. The laser beam is therefore less likely to be directed to the area outside the molten pool before the molten pool becomes large enough. As a result, such a disadvantage that occurs in the first comparative example can be reduced.

In the present embodiment, the length of the section from the Y-direction position P1 to the Y-direction position P2 is preferably set so that the circle 110 is formed twice or more at the corresponding wobbling pitch pt (see FIG. 23) in this section, and is more preferably set so that the circle 110 is formed seven to thirteen times at the corresponding wobbling pitch pt in this section. This allows moving to the section after the Y-direction position P2 (e.g., the section with the welding speed V3) after the molten pool is properly formed.

In the second comparative example, as shown in FIG. 25A, the welding speed is constant at a relatively low speed (=welding speed V1) in the entire section from the Y-direction position P1 to the Y-direction position P5. In this case, as schematically shown in FIG. 24B, in this case, as schematically shown in FIG. 25B, a melting width w2 (see the radial range D2 of the welding target portion 90 shown in FIG. 7) tends to be larger than a desired value. For example, when the laser beam is moved from the Y1 side toward the Y2 side, the melting width w2 increases as it gets closer to the Y2 side (same applies to the weld depth H1 shown in FIG. 13). As a result, not only the welding quality may decrease, but also disadvantages may occur due to the excessive melting width w2 and the excessive weld depth H1 (such as damage to a jig that positions the distal ends 40 of the coil pieces 52). Another disadvantage is that the welding time (time required for welding) per welding target portion 90 is relatively long.

According to the present embodiment, on the other hand, as described above, the relatively low welding speed V1 is used in the section from the Y-direction position P1 to the Y-direction position P2, but higher welding speeds (particularly the welding speed V3) are used in the subsequent sections. The melting width w2 and the weld depth H1 can thus be made substantially constant in the entire welding target portion 90 (i.e., in the entire section from the Y-direction position P1 to the Y-direction position P5). Moreover, the welding time (time required for welding) per welding target portion 90 can also be made relatively short. That is, such disadvantages that occur in the second comparative example can be reduced.

The three different welding speeds V1, V2, and V3 are used in the change profile of the welding speed of the present embodiment described above with reference to FIG. 21 etc. However, the welding speed V1 or the welding speed V3 may be used instead of the welding speed V2. Alternatively, four or more different welding speeds may be used.

Next, a manufacturing apparatus 300 will be briefly described together with the flow of a manufacturing method of the present embodiment with reference to FIG. 26.

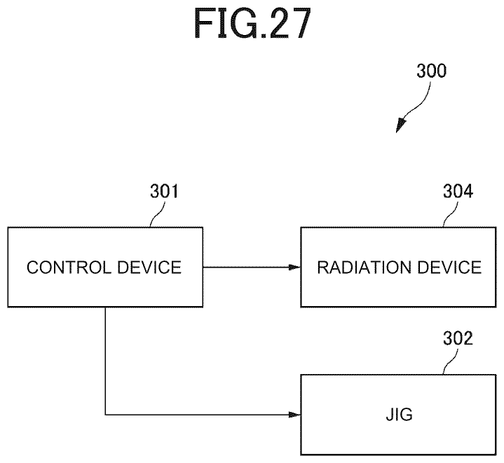

FIG. 26 is a flowchart schematically showing the flow of the method for manufacturing the stator 21 of the motor 1. FIG. 27 is a system configuration diagram of the manufacturing apparatus 300.

First, this manufacturing method includes an installation step of installing the coil pieces 52 in the stator core 22 (step S150). This manufacturing method further includes a joining step of joining the distal ends 40 of the coil pieces 52 by laser welding after the installation step (step S152). The method for joining the distal ends 40 of the coil pieces 52 by laser welding is as described above.

In this case, the joining step includes a setting step of setting the distal ends 40 of the coil pieces 52 so that the distal ends 40 of each pair of coil pieces 52 contact each other in the radial direction as described above (step S1521). In the setting step, the distal ends 40 of each pair of coil pieces 52 may be kept in contact with each other in the radial direction using a jig 302.

The joining step includes a radiation step of emitting a laser beam from a radiation device 304 to the welding target portion 90 as described above after the setting step (step S1522). The manner in which the laser beam is emitted from the radiation device 304 is as described above, and may be controlled by a control device 301. The setting step and the radiation step may be performed in batches of one or more predetermined number of welding target portions 90, or may be performed on all the welding target portions 90 of one stator 21 at a time. This manufacturing method may end when the stator 21 is completed by performing various necessary steps as appropriate after the joining step.

Although the embodiments are described in detail above, the present disclosure is not limited to the specific embodiments, and various modifications and changes can be made within the scope of the claims. It is also possible to combine all or part of the constituent elements of the embodiments described above.

### DESCRIPTION OF THE REFERENCE NUMERALS

1 . . . motor (rotating electrical machine), 24 . . . stator coil, 52 . . . coil piece, 40 . . . distal end, 401 . . . contact surface, 110 . . . circle representing laser beam, 300 . . . manufacturing apparatus, 302 . . . jig, 304 . . . radiation device

1. A method for manufacturing a stator for a rotating electrical machine, the method comprising:
a step of bringing distal ends of one coil piece and another coil piece that form a stator coil of the rotating electrical machine into contact with each other; and
a radiation step of emitting a laser beam with a wavelength of 0.6 μm or less toward one exposed side of a contact surface between the distal ends, wherein:
the radiation step includes scanning the laser beam in a loop while moving the laser beam in a direction of travel including a directional component in which the exposed side extends; and
an amount of movement in the direction of travel per loop scan is equal to or less than a beam diameter of the laser beam.

2. The method for manufacturing a stator for a rotating electrical machine according to claim 1, wherein in the radiation step, the laser beam is continuously emitted with a laser output of 3.0 kW or more for a plurality of the loop scans.

3. The method for manufacturing a stator for a rotating electrical machine according to claim 1, wherein a diameter of the loop or a length in a major-axis direction of the loop is between 1.4 times and 2.8 times the beam diameter of the laser beam.

4. The method for manufacturing a stator for a rotating electrical machine according to claim 1, wherein the beam diameter of the laser beam is 0.15 mm or more.

5. The method for manufacturing a stator for a rotating electrical machine according to claim 1, wherein the radiation step includes setting the amount of movement in the direction of travel per loop scan to a first amount of movement at start of radiation and then changing the amount of movement to a second amount of movement that is larger than the first amount of movement.

6. The method for manufacturing a stator for a rotating electrical machine according to claim 5, wherein the radiation step includes making a laser output of the laser beam higher in a section with the second amount of movement than in a section with the first amount of movement.

7. The method for manufacturing a stator for a rotating electrical machine according to claim 6, wherein the radiation step includes drawing a circle at least twice or more in the section with the first amount of movement by using the laser beam emitted so as to draw the circle a certain number of times per unit time.

8. An apparatus for manufacturing a stator for a rotating electrical machine, the apparatus comprising:
a jig configured to bring distal ends of one coil piece and another coil piece that form a stator coil of the rotating electrical machine into contact with each other; and
a radiation device configured to emit a laser beam with a wavelength of 0.6 μm or less toward one exposed side of a contact surface between the distal ends, wherein:
the radiation device is configured to scan the laser beam in a loop while moving the laser beam in a direction of travel including a directional component in which the exposed side extends; and
an amount of movement in the direction of travel per loop scan is equal to or less than a beam diameter of the laser beam.
